(19) United States
(12) Patent Application Publication
(10) Pub. No.: US 2009/0069923 A1
(43) Pub. Date: Mar. 12, 2009

(54) Method of managing a machine for manufacturing tobacco products

(76) Inventors: Fiorenzo Draghetti, Medicina (IT); Daniele Salvadeo, Monte San Pietro (IT)

Correspondence Address: Harbin King & Klima, 500 Ninth Street SE, Washington, DC, 20003, US

(21) Appl. No.: 11/918,751

(22) PCT Filed: Apr. 18, 2006
(86) PCT No.: PCT/IB2006/000888

§ 371 Date: Oct. 18, 2007

(30) Foreign Application Priority Data
Apr. 19, 2005 (IT) BO2005A000251

(51) Int. Cl. G06F 17/00

(52) U.S. Cl. 700/110

(57) ABSTRACT

A method of managing a machine for manufacturing tobacco products (2) includes the steps of monitoring the operation of single devices and/or units making up the machine (3; 4), and supplying error signals (48) to a master control unit (46) to indicate faults or malfunctions in any of the devices; on receiving an error signal (48), the control unit (46) responds automatically by stopping the machine (3; 4), activating a step in which obstructions are removed and foreign matter cleared from the faulty or malfunctioning device, and finally, with normal operating conditions restored, restarting the machine (3; 4).

### TECHNICAL FIELD

The present invention relates to a method of managing a machine for the manufacture of tobacco products, typically cigarettes.

Advantageously, the invention finds application in all machines of a cigarette manufacturing line, namely cigarette makers, filter tip attachment machines operating in combination with cigarette makers, also packers by which cigarettes are wrapped in single packets, and cartoners by which single packets are wrapped in multiples.

Reference is made explicitly in the following specification to a cigarette maker associated with a filter tip attachment machine, albeit implying no limitation in scope.

### BACKGROUND ART

It can happen during the normal operation of such machines that faults will occur and prevent the cigarettes from being formed correctly. Purely by way of example, a fault of the type in question could be: a blockage of the gumming nozzles located along the garniture section of the cigarette maker, which are thus rendered unable to apply a bead of gum correctly to the cigarette paper that envelops the stream of tobacco ultimately; or, the presence of a substandard segment of tobacco rod, advancing downstream of a cut-off device that will come into operation whenever sensing devices detect that the rod betrays characteristics rendering it unsuitable for the production of cigarettes; or again, a blockage on part of the feed path followed by the rod or by the cigarettes, caused by scraps of paper or tobacco; or finally, traces of gum, or scraps of paper, or cigarettes lying across a bed on which the tipping papers are rolled around the selfsame cigarettes.

Conventional machines will respond to a fault of the type described above, or to other such faults, by shutting down and relaying an alarm signal to a relative control panel, whereupon an operator can take action to remove the impediment by which the stoppage was caused, and then restart the machine, having first activated a clean-up procedure and run a series of checks to ensure that normal operation has been correctly restored.

The time elapsing between the detection of the fault and the subsequent restart of the machine can jeopardize the correct operation of other parts of the machine and, given the notably high operating speeds involved, has a significant impact on the quantity of cigarettes turned out during a shift.

The object of the present invention is to provide a method of managing a machine for the manufacture of tobacco products, such as will be unaffected by the aforementioned drawbacks.

In particular, the object of the invention is to provide a method of managing a machine for the manufacture of tobacco products, such as will enable a reduction in the downtime attributable to procedures by which correct operating conditions are restored following a stoppage.

### DISCLOSURE OF THE INVENTION

The stated object is duly realized in a method of managing a machine for the manufacture of tobacco products, as characterized in any one or more of the appended claims.

The invention will now be described in detail, by way of example, with the aid of the accompanying drawings, in which:

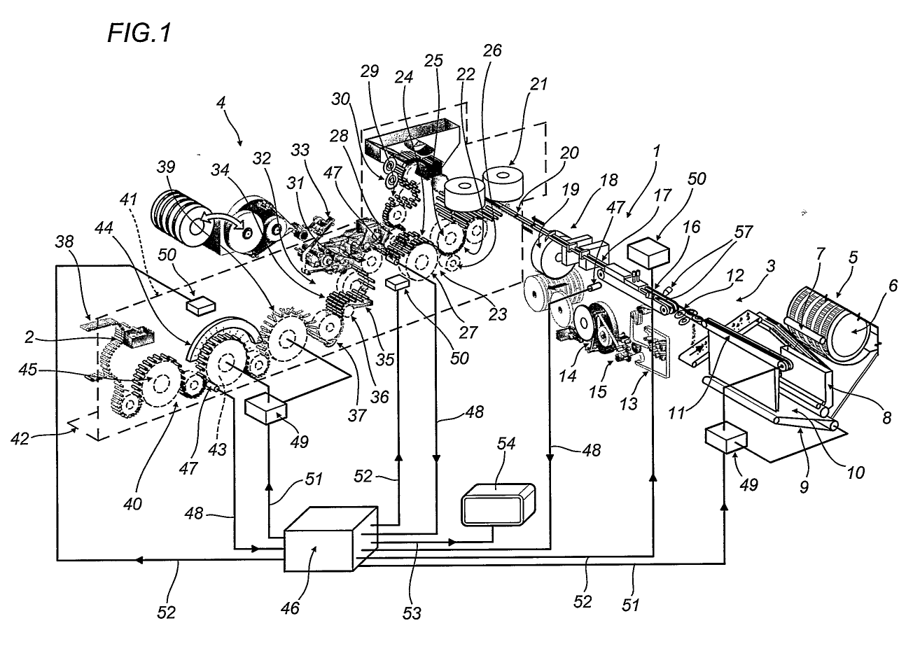

FIG. 1 illustrates a line for the manufacture of tobacco products, viewed in perspective, capable of implementing the method according to the present invention;

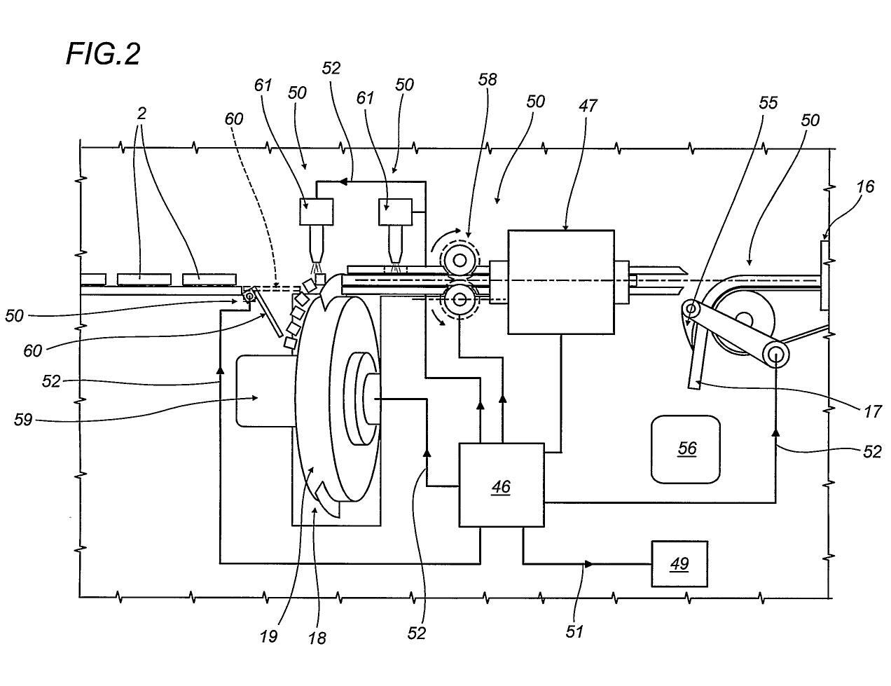

FIG. 2 shows a portion of the line in FIG. 1, illustrated in detail.

Referring to FIG. 1, numeral 1 denotes a line, in its entirety, for manufacturing tobacco products such as cigarettes 2, including a cigarette maker 3 and a filter tip attachment machine 4.

Whilst the method disclosed is illustrated with reference to the two types of machines mentioned above, it can be implemented on any machine used in the manufacture of tobacco products, such as a packer capable of fashioning rigid or soft packets, an overwrapper or cellophaner, and a cartoner or a carton overwrapper.

In general, a machine 3 or 4 for the manufacture of tobacco products 2 is equipped with a plurality of dedicated devices and/or machine units.

In particular, the cigarette maker 3 illustrated in FIG. 1 incorporates, proceeding from the upstream end of the line 1 toward the downstream end, a carding unit 5 supplied from a feed hopper (not indicated) with tobacco, which is taken up by a carding drum 6 operating in conjunction with an impeller roller 7 and directed into a descent channel or chute 8, passing thence by way of a belt conveyor 9 to a riser or chimney 10.

The top end of the chimney 10 is enclosed by an aspirating belt 11 on which particles of tobacco are caused to form gradually into a continuous stream 12 providing a filler for the cigarettes 2.

The stream 12 of tobacco is advanced together with a continuous strip 13 of paper decoiling from a roll 14, following a path along which a printer device 15 is stationed, and taken up by a garniture section 16 along which the paper strip 13 will be wrapped around the stream 12 to form a continuous cigarette rod 17.

The rod 17 advances toward a cutting station 18 where it is divided up by a rotary cutter device 19 into cigarette sticks 20 of predetermined constant length, and more exactly of length twice the length of a stick equivalent to a single cigarette 2.

Numeral 21 denotes a transfer device by which the successive double length cigarette sticks 20 are directed through an infeed roller stage 23 of the filter tip attachment machine 4 and into a cutting station 23 where each is divided into two single cigarette sticks 24 by the action of a roller 25 and a disc cutter 26.

The single sticks 24 are transferred from the roller 25 of the cutting station onto a distancing roller 27 that serves to separate the sticks 24 of each cut pair axially one from another, then onto an assembling roller 28, at which point a double length filter plug 29 dispensed from a feed unit, denoted 30 in its entirety, is placed between the two sticks 24 of the advancing pair.

The resulting assemblies, each composed of two single cigarette sticks 24 and a double length filter plug 29 interposed axially between them, are released by the assembling roller 28 to a roller 31 forming part of a finishing unit 32, which also includes a unit 33 serving to cut and feed single tipping papers 34, and a rolling mechanism 35 by which the stick-filter assemblies and the tipping papers 34 are received in succession and in such a manner that each paper 34 can be rolled around a corresponding assembly to fashion a cigarette 2 of double length.

The double length cigarettes 2 are directed by way of an intermediate roller 36 toward a cutter device 37 and divided each in turn by a stroke made through the double length filter plug 29, thus generating two identical successions of single filter cigarettes 2.

The two successions of filter cigarettes 2 are directed toward an outfeed unit 38 of the filter tip attachment machine 4, advancing first onto an overturning roller 39 by which the two successions are united to establish a single succession of cigarettes 2, then proceeding along a final train of rollers denoted 40 in its entirety, following a path along which the cigarettes 2 will undergo further processing steps of a familiar nature.

As illustrated by way of example in FIG. 1, the final train 40 of rollers, mounted together with the aforementioned rollers 22, 25, 27, 28 and 31 to a vertical bulkhead 41 carried by the frame 42 of the filter tip attachment machine 4, could also include a roller 43 on which the cigarettes 2 are pierced by a laser device 44, and a roller 45 on which the quality of the piercing is scanned.

The manufacturing line 1 for tobacco products 2 further comprises a master processing and control unit, or controller 46, which in the example of the drawings serves both the cigarette maker 3 and the filter tip attachment machine 4, but might equally well be dedicated to a single machine.

The controller 46 is connected to a plurality of sensors and detection units 47, shown schematically in the accompanying drawings, installed near or incorporated into the respective devices and/or machine units of the line and serving to detect any malfunction or fault in the machines 3 and 4, for example by monitoring the operation of the actual devices and/or units or inspecting the product processed by them. On finding a fault, the sensors or detection units 47 send an error signal 48 to the controller 46, which is connected in its turn to suitable motion-inducing means 49 (illustrated schematically in FIG. 1) associated with each of the various devices and/or units, and able thus to shut down the machine 3 or 4 or indeed the entire line 1.

FIG. 1 shows a number of sensors or detection units 47 located at various points along the line and serving, for example, to detect any malfunction of the gumming nozzles at the garniture section, or to identify a substandard segment of cigarette rod located beyond a cut-off device that will come into operation when the rod is found by quality control devices to be unsuitable for the production of cigarettes, or to sense any blockage on a part of the feed path followed by the cigarette rod or the cigarettes, caused by scraps of paper or tobacco, or, lastly, to detect the presence of gum or scraps of paper, or of cigarettes lying across a rolling bed on which tipping papers are wrapped around the cigarettes in the filter tip attachment machine.

The machine 3 or 4 will also be equipped with a plurality of clean-up units 50, illustrated as blocks in FIG. 1, connected to and governed by the controller 46 and mounted near to the devices and/or units aforementioned. The function of the units 50 in question is to clear the machine 3 or 4 of any material, for example, scraps of paper, tobacco, gum, or fragments of cigarette rod or cigarette sticks, that could disrupt the correct cigarette making process. The clean-up units 50 take the form, for example, of compressed air guns trained on the flutes occupied by the cigarette rod or sticks advancing along the feed path, brushes placed to sweep the rolling bed, swabs to wipe the gumming nozzles, or means serving to eliminate the substandard segments of tobacco rod 17.

On receiving the error signal 48 from the sensors or detection units 47, the controller 46 responds by outputting a signal 51 to the motion-inducing means 49 to shut down the machine 3 or 4, or at least a portion of the machine 3 or 4 with which the faulty or malfunctioning device or unit is associated.

Thereafter, the controller 46 outputs a further signal 52 to activate at least one clean-up step on the faulty or malfunctioning device and/or unit, attempting to restore the conditions that will enable the selfsame device and/or unit to restart automatically.

If conditions enabling restart of the machine 3 or 4 are not re-established after a first attempt at cleaning up the faulty device, the step will be repeated a predetermined number of times after which the controller 46 outputs an alert signal 53 to a warning device 54, illustrated as a display in FIG. 1, switching the machine 3 or 4 to stand-by until corrective action is taken by an operator.

Conversely, should the cause of the fault or malfunction be removed within the predetermined number of attempts, restoring conditions that will enable the machine 3 or 4 to restart, then the controller 46 restarts the machine automatically.

The controller 46 can also respond to the error signal 48 by automatically activating further steps of cleaning up all or certain of the remaining devices and/or units of the machine. To minimize downtime, each of the further clean-up steps would be performed simultaneously with that of cleaning up the faulty or malfunctioning device and/or unit and, ideally, activated only if the time Δt₁ needed to complete the step is less than or equal to the time Δt₂ needed to clean up the faulty device.

Given that the error signal 48 also contains information regarding the fault or malfunction, the control unit 46 is able to activate sequences of different clean-up steps according to the type of fault causing the stoppage. These same sequences are stored preferably in a database internally of the controller 46, and modifiable via software.

In this context, a sequence of steps will now be described, relating to a malfunction of a garniture section 16 equipped with a cut-off device 55 of the type disclosed in Italian Application EP 02425589.5 (filed in the name of the present applicant), which is illustrated in FIG. 2 for the sake of clarity.

The figure in question shows one of the detection units 47, located between the garniture section 16 and the cutting station 18 and serving to verify the correct formation of the cigarette rod 17.

Installed upstream of the detection unit 47 is a cut-off device 55, consisting in a movable member of familiar type, by which the continuous rod 17 is severed and diverted from the feed path as shown in FIG. 2.

When a defect in the cigarette rod 17 is detected by the unit 47, attributable for example to the presence of dirt on the channel of the garniture section 16, or to a malfunction of the gumming nozzles 57 (see FIG. 1) positioned to apply a layer of adhesive to the strip 13 before being wrapped around the stream 12 of tobacco, an error signal 48 is sent to the controller 46, which will respond by causing the cigarette maker 3 to shut down and generating the signal 52 to activate the cut-off device 55, whereupon the rod 17 is severed and diverted toward a recycle station denoted 56.

Immediately downstream of the cut-off device 55 and the detection unit 47, the portion of the tobacco rod 17 identified by the selfsame unit 47 as being defective is taken up by pinch rollers 58 and removed following the cut-off stroke. The same signal 52 that activates the cut-off stroke also causes the pinch rollers 58 to draw together so that the rod 17 is gripped and fed into the cutting station 18, activated likewise by the signal 52 and caused to rotate at a predetermined frequency typically faster than in normal operation, so as to chop up the discarded portion of the rod 17. The resulting fragments of rod 17 are diverted toward a recycle station 59 by means of a movable flap 60 mounted so as to pivot on an axis transverse to the feed path followed by the rod 17. Also activated by the aforementioned signal 52, finally, are pneumatic means 61 such as will direct a stream of compressed air along the channel of the garniture section 16 to remove any scraps of paper and tobacco. At the same time, the controller 46 will activate clean-up sequences for other devices and/or units of the machine 3 or 4.

In the event that the steps indicated above are sufficient to restore the conditions required for the machine to restart, the controller 46 will itself induce the restart having first deactivated the various clean-up units 50, which include the cut-off device 55, the pinch rollers 58 and the pneumatic means 61, and returned the flap 60 to a non-operating position indicated by phantom lines in FIG. 2.

Once the clean-up operations have been completed in automatic mode, the only two cases in which the controller 46 will output an alert signal 53 to the display 54 and switch the machine 3 or 4 to the stand-by condition until corrective action can be taken by an operator, are a breakage of the paper strip in which the stream of tobacco filler is wrapped, or the strip from which tipping papers are cut, and the depletion of production materials.

1. A method of managing a machine for manufacturing tobacco products, comprising the steps of monitoring the operation of a plurality of dedicated devices and/or machine units utilized in the manufacture of tobacco products (2), and supplying error signals (48) to a master processing and control unit (46) indicating any fault or malfunction in one of the devices and/or machine units, wherein the control unit (46) responds, on receiving the error signal (48), by causing the machine (3; 4) or a portion of the machine to shut down, characterized in that the control unit (46) responds also, on receiving the error signal (48), by automatically activating at least a step of cleaning up the device and/or machine unit affected by the fault or malfunction, so as to restore conditions enabling the restart of the machine (3; 4) or the portion of the machine.

2. A method as in claim 1, wherein the control unit (46) responds also, on receiving the error signal (48), by automatically activating clean-up steps performed on all or certain of the remaining devices and/or units of the machine (3; 4).

3. A method as in claim 2, wherein the single clean-up step performed on each of the remaining devices and/or units is activated only if the time (Δt₁) needed for its completion is less than or equal to the time (Δt₂) needed to clean up the device and/or unit affected by the fault or malfunction.

4. A method as in claim 1, wherein, if conditions enabling the restart of the machine (3; 4) are not restored after a first clean-up step performed on the device and/or unit affected by the fault or malfunction, the step is repeated a predetermined number of times.

5. A method as in claim 4 wherein, if the clean-up step is performed the predetermined number of times on the device and/or unit affected by the fault or malfunction without conditions enabling the restart of the machine (3; 4) being restored, the control unit (46) outputs an alert signal (53) to a warning device (54) and switches the machine (3; 4) to stand-by, allowing corrective action to be taken by an operator.

6. A method as in claim 1, wherein the restart of the machine (3; 4) is activated automatically by the control unit (46) following the completion of the clean-up steps and the restoration of conditions enabling the restart of the machine (3; 4).

7. A method as in claim 1, wherein the error signal (48) supplied to the control unit (46) indicates the type of fault or malfunction, and the control unit (46) responds by activating different sequences of clean-up steps for each type of fault or malfunction.

8. A method as in claim 1, wherein a break in paper feed or an absence of materials will cause the control unit (46) to respond also by outputting an alert signal (53) to a warning device (54) and switching the machine (3; 4) to stand-by, so that corrective action can be taken by an operator.

9. A method as in claim 1, wherein the clean-up step consists in removing portions of defective tobacco rod (17) from the garniture section of a machine (3) for making a continuous tobacco rod (17).

10. A method as in claim 1, wherein the clean-up step consists in directing a stream of compressed air along the garniture section of a machine (3) for making a tobacco rod (17), to remove scraps of paper and/or tobacco.

11. A method as in claim 1, wherein the clean-up step consists in wiping gumming nozzles (57) positioned along the garniture section of a machine (3) for making a continuous tobacco rod (17).

12. A method as in claim 1, wherein the clean-up step consists in utilizing a brush to sweep the rolling bed on which tipping papers are wrapped around a tobacco product (2) in a filter tip attachment machine (4).
